(19) United States
(12) Patent Application Publication
(10) Pub. No.: US 2017/0120184 A1
(43) Pub. Date: May 4, 2017

(54) METHOD FOR CLEANING A WASTE GAS FROM A METAL REDUCTION PROCESS

(71) Applicant: SIEMENS AKTIENGESELLSCHAFT, München (DE)

(72) Inventors: Bernd FRIEDRICH, Aachen (DE); Marc HANEBUTH, Nuremburg (DE); Alexander TREMEL, Erlangen (DE); Hanno VOGEL, Monheim (DE)

(73) Assignee: SIEMENS AKTIENGESELLSCHAFT, München (DE)

(21) Appl. No.: 14/770,063

(22) PCT Filed: Jun. 25, 2015
(86) PCT No.: PCT/EP2015/064323

§ 371 Date: Aug. 24, 2015

(30) Foreign Application Priority Data
Jul. 3, 2014 (DE) 102014212907.9

(51) Int. Cl. B01D 53/04; B01J 20/10; B01J 20/20; B01D 53/047; B01J 20/34

(52) U.S. Cl. CPC B01D 53/0462; B01D 53/047; B01J 20/3483; B01J 20/3491; B01J 20/3433; B01J 20/3416; B01J 20/20; B01J 20/205; B01J 20/103; B01D 2253/102; B01D 2253/106; B01D 2253/116; B01D 2257/2066; B01D 2259/818

(57) ABSTRACT

Gaseous perfluorocarbons in a waste gas are adsorbed by an adsorption device. Subsequently a decomposition of the perfluorocarbons takes place with formation of hydrogen fluoride. The hydrogen fluoride is converted with an oxide of a metal to be reduced, to the metal fluoride thereof. The metal fluoride formed is then fed again to the reduction process.

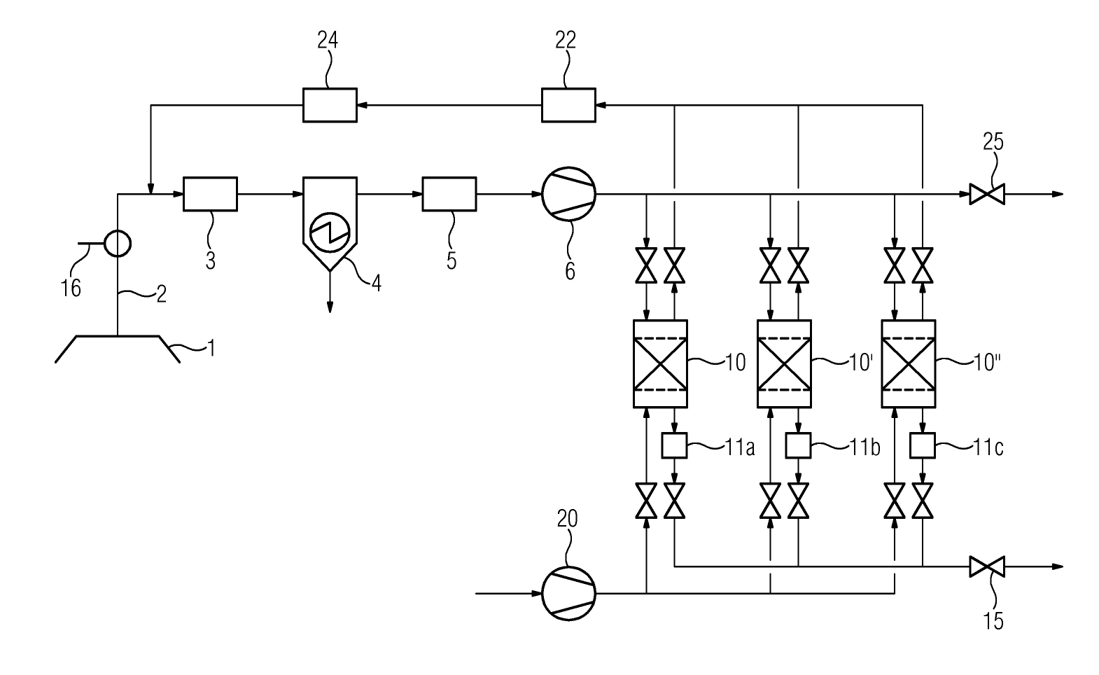

The invention relates to a method for cleaning a waste gas from a metal reduction process according to claim 1.

Different metals, for example, aluminum or metals belonging to the rare earth elements are isolated as elements with the aid of fused salt electrolysis by chemical reduction from the relevant starting substances (for simplification, this is referred to hereinafter as a metal reduction process). This process takes place using an electrolyte which is often based on a fluorine compound, at a temperature of approximately up to 1100° C. In this process, the liquid electrolyte always evaporates slightly and, together with moisture in the surrounding air, forms hydrogen fluoride, also known as hydrofluoric acid. This leads to an appreciable loss of fluorine in the process. The starting substance, typically the oxide of the metal to be extracted is practically continuously fed into the electrolysis cell and dissolves in the electrolyte. Subsequently, the metal is separated out cathodically and, anodically, carbon monoxide and carbon dioxide are formed with the graphite of the anode. As the oxide in the electrolyte becomes depleted close to the anode, it cannot be prevented that during “anode effects” fluorine also reacts with the anode carbon and gaseous perfluorocarbons are formed. Perfluorocarbons of this type possess a greenhouse gas potential which exceeds that of carbon dioxide, which is also known as a greenhouse gas, by a multiple of several thousand times. It is therefore of great significance appreciably to lessen the formation of perfluorocarbons. For this purpose, in the past, particularly in the aluminum processing industry, suitable measures have been taken, which are established particularly in the field of process optimization. However, it cannot be prevented that “anode effects” arise and that in particular process situations, perfluorocarbons such as CF₄ or C₂F₆ are formed.

The object of the invention lies in providing a method for cleaning a waste gas arising from a metal reduction process which again significantly lessens the emission of perfluorocarbons as compared with the prior art.

The achievement of this object lies in a method having the features of claim 1.

The method according to the invention for cleaning a waste gas from a metal reduction process according to claim 1 serves, in particular, for the removal of gaseous perfluorocarbons from said waste gas. An adsorption device is provided which can also be designated an adsorption bed in which the perfluorocarbons are adsorbed and subsequently a decomposition of the perfluorocarbons takes place with the formation of hydrogen fluoride. The hydrogen fluoride formed therein is converted, with an oxide of the metal to be reduced, to the metal fluoride thereof and the metal fluoride formed is then fed again to the reduction process.

The advantage of this invention lies therein that, particularly during a fused salt electrolysis process during the manufacturing of metal, that is, the reduction of higher oxidation states of the element from an ore to elemental metal, particularly of aluminum or rare earth metal isolation, the at least temporarily arising perfluorocarbons can be removed almost entirely from the waste gas and in that fluorine thereby recovered can be fed to the process again, which additionally reduces the fluorine loss, which is technically complex to treat and always occurs during fused salt electrolysis.

In a further embodiment of the invention, a sensor system is provided for detecting perfluorocarbons and wherein the waste gas is only fed over the adsorption device if a pre-set limit value of the perfluorocarbons is exceeded. This is suitable since the aforementioned anode effects which lead to the formation of the fluorocarbon compounds arise only temporarily in a largely well-controlled metal reduction process. Since the loading of the adsorption devices, that is, the adsorption and the desorption necessarily resulting therefrom, that is, the discharging of the adsorption device also requires a certain energy input, it is suitable to connect in the adsorption device only when the corresponding limit values of the perfluorocarbons are exceeded.

An advantageous embodiment of the adsorption device consists in a “pressure swing adsorption device” wherein the adsorption of the perfluorocarbons takes place under the effect of pressure and a corresponding pressure reduction is undertaken for the desorption.

A further suitable principle for operating the adsorption device is the “temperature swing adsorption principle” wherein the adsorption takes place by means of a temperature reduction and, in a similar use, a temperature increase is required for the desorption.

Activated carbon, carbon nanotubes or a molecular sieve, for example silicalite-1, in particular, have proved to be advantageous as adsorption materials.

The perfluorocarbons which are removed from the adsorption device are preferably thermally decomposed and decomposition by means of a plasma device is also suitable.

According to a further embodiment of the invention, it is suitable to provide at least two adsorption devices so that the adsorption and desorption process can take place continuously.

Further embodiments of the invention and further features are described in greater detail in the following specific description, particularly making reference to the single drawing,

in which:

the FIGURE shows a schematic process for separating perfluorocarbons out of a waste gas from a metal reduction process, making use of an adsorption device.

In the following description, the method for cleaning waste gases from a metal reduction process will be described making reference to the example in the FIGURE.

The actual metal reduction process, which is not shown in detail here, takes place under an enclosure 1. In order to draw off as much as possible of the gases arising during the reduction process, it is useful to provide an enclosure 1 for the overall metallurgical process that is as encompassing as possible, providing this is economically realizable. The waste gas 2 which is drawn off from the metal reduction process is checked, in particular, for the presence of perfluorocarbons by means of a sensor 16. This sensor system 16 can be arranged at a variety of points in the method described below. The arrangement shown in the FIGURE has a purely exemplary character.

In the next step, the waste gas is fed through a device identified quite generally as a binding device 3 which can be configured in the form of a packed bed or a fluidized bed reactor and in which the waste gas and the solids contained therein are filtered. When using a filter layer, this consists, in particular, of the oxides of the metal which is being produced reductively. For the reductive isolation of aluminum, therefore, aluminum oxide is contained in the filter layer and if rare earth compounds are to be reduced, then, for example, the oxides of lanthanum or neodymium or praseodymium are provided in the filter layer.

In this filter layer, for example, for the isolation of neodymium, the powdered neodymium oxide is then converted by the gaseous HF (hydrogen fluoride or hydrofluoric acid) to neodymium fluoride and water. Powdered neodymium fluoride and lithium fluoride is also held back in this filter layer. The advantage of using the relevant oxide of the metal to be reduced, in this example, neodymium oxide in neodymium fused salt electrolysis, as the adsorption oxide lies in the possibility of utilizing this oxide loaded with fluorides again directly in the fused salt electrolysis process. Thus, in the event of, for example, lanthanum electrolysis, lanthanum oxide should also be used as an absorption means. By means of the separation of the fluoride from the waste gas and the discontinuous feed-back, the fluoride loss in the metal reduction process can be reduced to a minimum.

An example thereof is that in the conventional production of neodymium, per kilogram of elemental neodymium extracted, approximately 0.1 kg neodymium fluoride and approximately 0.01 kg lithium fluoride are needed in addition. There is therefore a large saving potential in the use of the necessary process additives. If too many fine fluoride particles pass this binding device 3 or if oxide particles are carried out in powder form, an electrical precipitator 4 can optionally be connected downstream. In said precipitator, the remaining fine particles are electrically charged and separated out of the waste gas stream at another electrode.

Downstream from the electrical precipitator, the waste gas stream ideally consists of air that is laden with carbon dioxide and carbon monoxide and with the undesirable carbon fluorides, for example, perfluorocarbons. This is cooled, if necessary, in a cooling device 5. A fan 6 then conveys this gas stream into the adsorber device, configured in the form of adsorber beds 10, 10′, 10″ which are connected in parallel in relation to the waste gas stream. Preferably, it is always only a part of the adsorber beds 10, 10′, 10″ that is operated. The other adsorber beds can be simultaneously desorbed or they are held ready as a back-up in case an increased demand for the adsorption of perfluorocarbons exists.

The aforementioned gaseous components, in particular, the perfluorocarbons, can be absorbed through the use of adsorbents, for example, activated carbon, carbon nanotubes or hydrophobic molecular sieves, for example, silicalite-1 in the adsorption devices. Herein, two different adsorption methods can suitably be used, firstly “pressure-swing adsorption” (PSA) or secondly “temperature-swing adsorption” (TSA). Depending on the embodiment, either PSA or TSA, temperature or pressure changes are required in order suitably to adsorb the perfluorocarbons out of the waste gas. Whether one of the adsorption beds 10 is fully loaded can be detected in general by means of the escape of perfluorocarbons. For this purpose, sensors 11, 11′, 11″ are utilized downstream of the adsorption beds 10. The desorption takes place in the opposing direction of flow. A fan 20 then conveys fresh air through the adsorption beds 10, 10′, 10″. The desorption is triggered either by a pressure change (PSA) or a temperature change (TSA). The perfluorocarbons are generally present in a high concentration in the gas phase and, if required, can be decomposed in a separation module 22 in a decomposition module 24 following the separation of carbon monoxide and carbon dioxide. The decomposition of the perfluorocarbons preferably takes place in the form of a thermal decomposition, for example, through the use of a burner also fueled, for example, by natural gas. However, a decomposition by means of a plasma can also take place. The thermal decomposition then leads, due to the presence of water vapor in the flame, to the formation of hydrofluoric acid (HF). If a plasma burner is used, water or water vapor is actively added thereto in order also to enable the formation of HF.

The gas stream then laden with HF is subsequently fed back into the waste gas cleaning module 3. HF can be bound to the oxides which are present in gas cleaning module 3 and the hydrofluoric acid is fed again as a fluoride to the electrolysis, as described. By means of the overall process as described for treating waste gas from the metal reduction process, the release of fluorine or fluorine compounds to the environment is prevented. Furthermore, the raw material-intensive fluorine loss which occurs in the method according to the prior art is minimized.

Adsorption materials typically have the property of binding a large number of different molecule types. In the case of the present method, the adsorption of perfluorocarbons is in competition with the adsorption of carbon dioxide or carbon monoxide, which are naturally also present in the waste gas when carbon anodes are used for reducing the desired metal.

It can therefore be useful selectively to use adsorption materials which act on perfluorocarbons. If this is not suitable for economic or technical reasons, it is useful to put the above-described sensor systems 16 into use and to measure the actual content of perfluorocarbons in the waste gas 2. In modern production control systems, particularly for the reduction of aluminum salts to aluminum, the perfluorocarbons in the waste gas 2 occur only temporarily when the “anode effects” arise. It is therefore suitable only to guide the waste gas 2 through the adsorption device 10 if a pre-set limit value of perfluorocarbons in the waste gas 2 is exceeded. For this purpose, a valve 25 is provided which is always open during normal operation of the device and is only closed when the limit value of perfluorocarbons in the waste gas 2 is exceeded. In this case, the waste gas 2 is diverted via the adsorption devices 10 and/or 10′ and/or 10″ and the perfluorocarbon is removed from the waste gas 2. It is herein suitable that normally only one adsorption device 10 or 10′ is in operation so that one further or two further adsorption devices 10′ and 10″ are in a desorption operation, that is, are discharged of the stored perfluorocarbons. These perfluorocarbons are again fed, as described, via the CO₂ separation device 22 and the decomposition module 24, to the binding device 3. The use of the separation device 22 for separating out carbon monoxide or carbon dioxide is suitable if a less selective adsorption medium is used in the adsorption devices 10 so that the gas which is removed from the adsorption devices 10, 10′, 10″ contains a high proportion of carbon dioxide and/or carbon monoxide. The decomposition of the perfluorocarbons in the decomposition devices 24 is significantly less energy-intensive if the carbon dioxide has previously been separated out of the gas stream.

1-9. (canceled)

10. A method for cleaning a waste gas from a metal reduction process, comprising:
adsorbing gaseous perfluorocarbons in the waste gas by an adsorption device;
forming hydrogen fluoride by decomposing the perfluorocarbons obtained from said adsorbing;
converting the hydrogen fluoride, using an oxide of a metal to be reduced, to a metal fluoride of the metal to be reduced; and
feeding the metal fluoride formed by said converting to the metal reduction process.

11. The method as claimed in claim 10,
further comprising detecting perfluorocarbons by a sensor system, and
wherein the waste gas is supplied to the adsorption device if a pre-set limit value of the gaseous perfluorocarbons is exceeded.

12. The method as claimed in claim 10, wherein the adsorption device is operated according to a pressure swing adsorption principle.

13. The method as claimed in claim 10, wherein the adsorption device is operated according to a temperature swing adsorption principle.

14. The method as claimed in claim 10, wherein adsorption materials in the adsorption device are selected from the group consisting of activated carbon, carbon nanotubes and a molecular sieve.

15. The method as claimed in claim 10, wherein adsorption materials in the adsorption device include silicalite-1.

16. The method as claimed in claim 10, wherein said forming of the hydrogen fluoride is by thermally decomposing the perfluorocarbons.

17. The method as claimed in claim 10, wherein the perfluorocarbons are decomposed by a plasma device.

18. The method as claimed in claim 10,
wherein said adsorbing uses at least two adsorption devices, and
wherein said method further comprises alternately charging and discharging the at least two adsorption devices.

19. The method as claimed in claim 10, further comprising discharging the adsorption device by at least one of a temperature change and a pressure change.
